(19) United States
(12) Patent Application Publication
(10) Pub. No.: US 2015/0078233 A1
(43) Pub. Date: Mar. 19, 2015

(54) METHOD, TERMINAL, AND SYSTEM FOR PERFORMING MOBILE COMMUNICATION

(71) Applicant: Samsung Electronics Co., Ltd., Gyeonggi-do (KR)

(72) Inventor: Surendra SINGH, Gyeonggi-do (KR)

(73) Assignee: Samsung Electronics Co., Ltd.

(21) Appl. No.: 14/487,596

(22) Filed: Sep. 16, 2014

(30) Foreign Application Priority Data
Sep. 16, 2013 (KR) 10-2013-0111182

(51) Int. Cl. H04W 52/02; H04W 88/08; H04W 4/00

(52) U.S. Cl. CPC H04W 52/0209; H04W 4/008; H04W 88/08
USPC 370/311

(57) ABSTRACT

Provided is a method of providing mobile communication information. The method includes acquiring, by a master terminal, mobile communication information necessary for using mobile communication services in a predetermined area, wherein the master terminal is connected to at least one slave terminal via a predetermined network and transmitting the mobile communication information to the at least one slave terminal via the predetermined network.

### RELATED APPLICATIONS

This application claims priority to Korean Patent Application No. 10-2013-0111182, filed on Sep. 16, 2013, in the Korean Intellectual Property Office, the disclosure of which is incorporated herein in its entirety by reference.

### BACKGROUND

1. Field of the Invention

One or more embodiments of the present invention relate to a method, terminal, and system for performing mobile communication, and more particularly, to a method, terminal, and system for performing mobile communication by using a master terminal among a plurality of terminals.

2. Description of the Related Art

To use mobile communication services, a mobile terminal needs to continually connect with a mobile communication network. Specifically, a base station that allows a mobile terminal to use mobile communication services has to be registered with the mobile communication network.

Thus, the mobile terminal must periodically transmit data to and receive data from the mobile communication network in order to use mobile communication services. However, the periodic transmission and reception of data may consume a large amount of battery power of the mobile terminal. Since the battery capacity of the mobile terminal is greatly limited due to a size of the mobile terminal, it is necessary to minimize battery consumption in the mobile terminal.

### SUMMARY

One or more embodiments of the present invention include a method, terminal, and system for performing mobile communication by connecting to a mobile communication network through a master terminal.

Additional aspects will be set forth in part in the description which follows and, in part, will be apparent from the description, or may be learned by practice of the presented embodiments.

According to one or more embodiments of the present invention, a method of providing mobile communication information includes: a master terminal acquiring mobile communication information necessary for using mobile communication services in a predetermined area, wherein the master terminal is connected to at least one slave terminal via a predetermined network; and transmitting the mobile communication information to the at least one slave terminal via the predetermined network.

The method may further include registering information about the at least one slave terminal with a mobile communication network by using the mobile communication information, upon request of the at least one slave terminal, so that the at least one slave terminal is connected to the mobile communication network.

The method may further include providing, upon request of the at least one slave terminal, the mobile communication services to the at least one slave terminal by using the mobile communication information, wherein the mobile communication services include at least one of text messaging, calling, and data provision services.

The acquiring of the mobile communication information includes acquiring the mobile communication information at predetermined time intervals.

The predetermined network may be a short-range communication network.

The mobile communication information may include a list of mobile communication service providers of each mobile communication network that is connectable with a mobile terminal in the predetermined area.

According to one or more embodiments of the present invention, a method of connecting to a mobile communication network includes: connecting to a master terminal via a predetermined network; receiving mobile communication information including information necessary for using mobile communication services in a predetermined area from the master terminal via the predetermined network; and connecting to a mobile communication network by using the received mobile communication information.

The connecting to the mobile communication network may include registering information about at least one slave terminal with the mobile communication network by using the mobile communication information so that the at least one slave terminal is connected to the mobile communication network.

The registering of information about the at least one slave terminal may include determining a base station that will receive an incoming call, from among base stations that are connectable in the predetermined area; and registering information about the at least one slave terminal with the mobile communication network based on a result of determination.

The connecting to the mobile communication network may further include receiving the incoming call through the determined base station.

The mobile communication information may include a list of mobile communication service providers of each mobile communication network that is connectable with a mobile terminal in the predetermined area. The connecting to the mobile communication network may include selecting at least one mobile communication service provider from the list of mobile communication service providers and connecting to a mobile communication network used by the selected mobile communication service provider.

The receiving of the mobile communication information may include receiving the mobile communication information at predetermined time intervals and updating the mobile communication information with the received mobile communication information, and the connecting to the mobile communication network may include connecting to the mobile communication network by using the updated mobile communication information.

The predetermined network may be a short-range communication network

A mobile terminal according to the one or more embodiments of the present invention continuously connects to a mobile communication network through a master terminal, thereby reducing battery consumption therein.

The mobile terminal may also acquire mobile communication information necessary for using mobile communication services, thereby reducing battery consumption therein.

Furthermore, the mobile terminal may use mobile communication services through a master terminal in the absence of a base station connectable thereto.

In addition, the mobile terminal may access mobile communication services through a master terminal capable of using the mobile communication services.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a system for performing a mobile communication method according to an exemplary embodiment of the present invention;

FIG. 2 is a block diagram of an internal configuration of a master terminal according to an exemplary embodiment of the present invention;

FIG. 3 is a block diagram of an internal configuration of a slave terminal according to an exemplary embodiment of the present invention;

FIG. 4 is a flowchart of a method in which a mobile terminal provides mobile communication information according to an exemplary embodiment of the present invention;

FIG. 5 is a flowchart of a method in which a master terminal provides mobile communication information and mobile communication services according to an exemplary embodiment of the present invention;

FIG. 6 is a flowchart of a method of receiving mobile communication information in a slave terminal according to an exemplary embodiment of the present invention;

FIG. 7 is a flowchart of a method of receiving mobile communication information and mobile communication services in a slave terminal according to an exemplary embodiment of the present invention;

FIGS. 8 and 9 are exemplary diagrams of a method of providing mobile communication information and mobile communication services according to exemplary embodiments of the present invention; and

FIG. 10 is a flowchart of a method of providing mobile communication information and mobile communication services according to another exemplary embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention. Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Exemplary embodiments will now be described in detail with reference to the accompanying drawings.

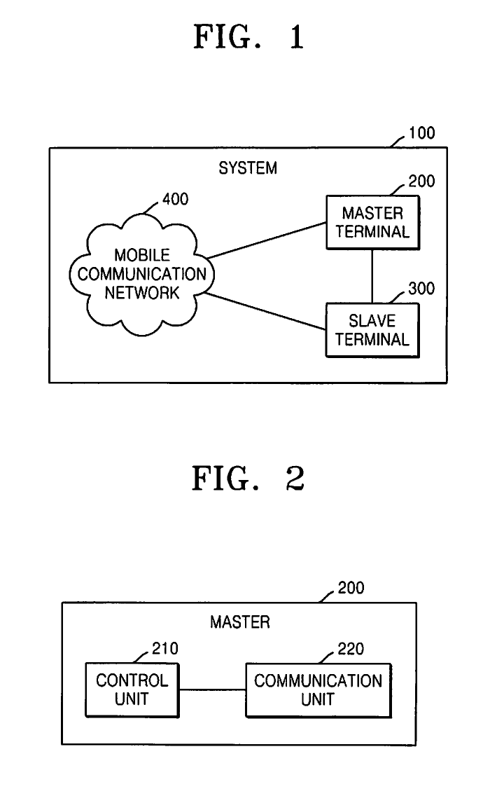

FIG. 1 is a block diagram of a system for performing a mobile communication method according to an exemplary embodiment of the present invention.

Referring to FIG. 1, the system according to the present embodiment includes a master terminal 200, a slave terminal 300, and a mobile communication network 400.

Each of the master terminal 200 and the slave terminal 300 may be various types of devices that are connected to the mobile communication network 400 and are used by a user who is able to access mobile communication services. For example, each of the master terminal 200 and the slave terminal 300 may be at least one of a mobile phone, a smart phone, a smart camera, a Personal Digital Assistant (PDA), a Portable Multimedia Player (PMP), a navigation system, a tablet PC, and the like. The master terminal 200 and the slave terminal 300 are not limited thereto, and may be interpreted as a concept including devices that are being developed for commercial use or will be developed for the future.

The master terminal 200 and the slave terminal 300 may transmit and receive data over a wired or wireless network. In one embodiment, the master terminal 200 may transmit mobile communication information that is acquired from the mobile communication network 400 and necessary for using mobile communication services over a wired or wireless network.

The mobile communication network 400 may include a base station and a mobile switching center. The base station routes information that a user desires to transmit to the mobile switching center through which the information is then sent to a desired mobile terminal. The base station may also transmit information received from the mobile switching center to a mobile terminal.

The mobile communication center is connected to a Public Switched Telephone Network (PSTN) or another mobile communication center to transmit and receive information desired by a user. The PSTN refers to a network that connects a telephone line to a telephone exchange to allow subscribers to make/receive phone calls to/from one another. The PSTN may provide telephone switching services to an unspecified and large number of subscribers.

Thus, a mobile terminal may convert information that is needed for using mobile communication services including at least one of voice calling, text messaging, and data services into an electrical signal to transmit the electrical signal to a base station or receive information from the base station via radio waves.

Since each base station covers a limited area where it can transmit/receive information to/from a mobile terminal, the mobile communication network 400 may include a plurality of base stations, each covering a maximum range of area for providing mobile communication services to a mobile terminal. In other words, the mobile communication network 400 may include a plurality of base stations that can transmit and receive data in a particular frequency band to and from a mobile terminal located within a predetermined area, the predetermined area having a base station at the center thereof. Thus, according to the location of the mobile terminal, the mobile terminal may search for a base station that may provide mobile communication services and use the mobile communication services through a found base station.

Before transmitting information necessary for using mobile communication services including calling, text messaging, or data services to a mobile terminal, it is necessary to register information about the mobile terminal with the mobile communication network 400. The information about the mobile terminal contains information about a base station to which the mobile terminal is able to connect. For example, the information about the mobile terminal may be prestored on a server for storing a location of the mobile terminal in the mobile communication network.

Incoming calls or data may be sent to a mobile terminal through a base station connected to the mobile terminal based on the information about the mobile terminal pre-registered with the mobile communication network. Thus, in order for the mobile terminal to use mobile communication services through the mobile communication network 400, information about the mobile terminal may be registered in advance with the mobile communication network 400 through a base station to which the mobile terminal is able to connect. As described above, the information about the mobile terminal may include information about the base station.

Since a mobile terminal may be moved by a user, the location of the mobile terminal may change in real time. In other words, information about the mobile terminal containing information about a base station to which the mobile terminal is able to connect may vary in real time as the mobile terminal moves. Thus, the mobile terminal may periodically search for a base station to which the mobile terminal is able to connect according to the current location of the mobile terminal in order to register information about the mobile terminal containing information about the base station with the mobile communication network 400. The mobile terminal may also periodically register the information about the mobile terminal with the mobile communication network 400 through a base station to which the mobile terminal is able to connect. That is, the mobile terminal may periodically acquire mobile communication information necessary for using mobile communication services while at its current location and register information about the mobile terminal with the mobile communication network 400 by using the acquired mobile communication information. The information about the mobile terminal to be registered with the mobile communication network 400 may include information about a base station that covers an area in which the mobile terminal is currently located and is able to receive a signal from the mobile terminal.

However, since a location of the mobile terminal may vary in real time, information about the mobile terminal may be periodically registered with the mobile communication network 400. In other words, the mobile terminal may periodically acquire mobile communication information containing information about a base station with which to exchange signals at its current location and determine a base station that transmits and receives data with the mobile communication network 400 based on the mobile communication information. The mobile terminal may also register information about the mobile terminal with the mobile communication network 400 through the base station determined according to the mobile communication information. Thus, periodical acquisition of the mobile communication information by the mobile terminal and registration of the information about the mobile terminal may result in continuous battery consumption.

In one embodiment, to solve the above problem, the master terminal 200 may periodically acquire mobile communication information necessary for using mobile communication services in a predetermined area instead of the slave terminal 300. That is, the master terminal 200 may periodically acquire mobile communication information including information about a base station based on a current location of the master terminal 200 or slave terminal 300. The slave terminal 300 may periodically receive mobile communication information from the master terminal 200 and register information about the slave terminal 300 with the mobile communication network 400 by using the acquired mobile communication information.

The slave terminal 300 may determine a base station to which the slave terminal 300 will connect to exchange data with the mobile communication network 400, from among base stations based on the mobile communication information received from the master terminal 200. Then, the slave terminal 300 may register information about the slave terminal 300 with the mobile communication network 400 through the determined base station. Alternatively, the slave terminal 300 may register information about the slave terminal 300 with the mobile communication network 400 through the master terminal 200 by requesting the master terminal 200 to register the information therewith.

In one embodiment, the master terminal 200 and the slave terminal 300 may be located sufficiently close to each other such that the master terminal 200 and the slave terminal 300 may communicate with each other via a short range network. The short range network may include the short-range wireless network and the wired communication network. However, when the master terminal 200 and the slave terminal 300 are able to communicate by using a communication technique other than a mobile communication method, the master terminal 200 and the slave terminal 300 may form the same group. For example, the master terminal 200 and the slave terminal 300 may be connected to each other via a wired network.

However, since the master terminal 200 may obtain mobile communication information necessary for using mobile communication services at the current location thereof, the master terminal 200 may be located within a predetermined distance from the slave terminal 300. The master terminal 200 and the slave terminal 300 may also be located in an area where they are able to receive signals from the same base station. Furthermore, the slave terminal 300 may also access mobile communication services by using mobile communication information acquired by the master terminal 200 at the location of the slave terminal 300. Thus, a group to be formed may be determined based on a distance between the master terminal 200 and the slave terminal 300. In other words, the group may be formed according to whether the slave terminal 300 is located within a predetermined distance from the master terminal 200.

A reference distance that is between the master terminal 200 and the slave terminal 300 and used to form a group may be determined based on a cell size. A cell may refer to a predetermined area in which each terminal can receive mobile communication services through one base station. In other words, a cell may mean an area covered by each base station that transmits signals to terminals so as to provide mobile communication services. However, the reference distance between the master terminal 200 and the slave terminal 300 is not limited to a cell size, but may be determined by using various methods.

In one embodiment, when users carrying their own mobile terminals are located within a predetermined distance, the mobile terminals may form a single group including the master terminal 200 and the slave terminal 300. For example, if users of a plurality of mobile terminals travel together by car, walk in a group, or get together within a predetermined space, the mobile terminals possessed by the users may form a single group. The mobile terminals in the group may be connected to one another via a short-range wireless or wired network. Thus, a mobile terminal set as the slave terminal 300 may periodically acquire mobile communication information from the master terminal 200 or register information about the mobile terminal with the mobile communication network 400 through the master terminal 200. This configuration may reduce battery consumption of the slave terminal 300 that results from periodic acquisition of the mobile communication information and registration of the information about the mobile terminal.

In one embodiment, the mobile communication network 400 to which the master terminal 200 or the slave terminal 300 is able to connect may include one of first through fifth generation mobile communication networks.

Furthermore, a wired or wireless network that may be connected between the master terminal 200 and at least one slave terminal 300 may include at least one of different types of networks known in the art as well as a next-generation communication network to be developed in the future. Examples of the different types of networks may include, but are not limited to, an Internet Protocol (IP) network for providing large volume data transmission/reception services and seamless data services via IP, an All-IP network having an IP network structure that incorporates other networks based on IP, a Wireless Broadband (WiBro) network, a wireless local area network (WLAN), a wireless personal area network (WPAN), a wireless metropolitan area network (WMAN), a wired communication network, a high speed downlink packet access (HSDPA) network, a short-range wireless network, and a satellite communication network.

The short-range wireless network may include at least one of Bluetooth, ZigBee, Radio Frequency Identification (RFID), infrared Data Association (IrDA), and Ultra Wideband (UWB) networks. The wired communication network may include, but is not limited to, one of a High Speed Downlink Packet Access (HDMI), Institute of Electrical and Electronics Engineers (IEEE) 1394, a serial port, a parallel port, and a universal serial bus (USB) interface.

Communication methods for the above-described networks are not limited thereto, and may be construed to include a communication method that is being developed for commercial use or will be developed in the future.

In one embodiment, applications may be installed on the master terminal 200 and the slave terminal 300, respectively, in order for the master terminal 200 to transmit mobile communication information to the slave terminal 300. In other words, each mobile terminal may be determined as the master terminal 200 or the slave terminal 300 by an application installed on the mobile terminal. The mobile terminal may also perform a mobile communication method as the master terminal 200 or slave terminal 300 according to the application.

The master terminal 200 and at least one slave terminal 300 may together form a single group. That is, a plurality of mobile terminals may form a group, and at least one master terminal 200 and at least one slave terminal 300 may be determined from among the plurality of mobile terminals in the group.

For example, the master terminal 200 may be determined based on the remaining amount of battery in each of the mobile terminals in the group.

Alternatively, the master terminal 200 may be determined according to the amount of time when each of the mobile terminals in the group is available. The amount of available time may be determined based on at least one of the remaining amount of battery and the amount of battery consumed per unit time

The master terminal 200 may also be determined according to whether each of the mobile terminals in the group is being charged.

The master terminal 200 may also be determined according to whether each of the mobile terminals in the group is connected to the mobile communication network 400 to access mobile communication services. For example, if a mobile communication service provider that provides mobile communication services to each mobile terminal varies from one mobile terminal to another, whether a mobile terminal is able to exchange data with the mobile communication network 400 may vary depending on a location of the mobile terminal.

The master terminal 200 may also be determined according to a rate for mobile communication services that is used by each of the mobile terminals in the group. For example, a mobile terminal offering the lowest usage rate of mobile communication services may be set as the master terminal 200.

The master terminal 200 may also be determined when the slave terminal 300 requests a particular mobile terminal to provide mobile communication information. The mobile terminal that received such a request from the slave terminal 300 may be determined as the master terminal 200 by setting the request or accepting the request according to a user input.

FIG. 2 is a block diagram of an internal configuration of the master terminal 200.

Referring to FIG. 2, the master terminal 200 may include a control unit 210 and a communication unit 220. However, all of the components illustrated in FIG. 2 are not essential components. The master terminal 200 may be realized by fewer or more components than those illustrated in FIG. 2.

The control unit 210 may generally control overall operations of the master terminal 200. For example, the control unit 210 may acquire mobile communication information necessary for using mobile communication services in a predetermined area and control operation of the communication unit 220 so that the communication unit 220 sends the mobile communication information to at least one slave terminal (300 in FIG. 1) over a predetermined network. That is, the control unit 210 may control the overall operation of the communication unit 220.

In one embodiment, the mobile communication information may include information about a base station to which a mobile terminal is able to connect in a predetermined area. The information about the base station may include at least one of identification (ID) information, location, and signal strength of the base station and information about the mobile terminal currently being connected to the base station. The control unit 210 may also periodically acquire mobile communication information and control operation of the communication unit 220 so that the communication unit 220 transmits the mobile communication information to the slave terminal 300. Although the control unit 210 acquires the mobile communication information through the mobile communication network (400 in FIG. 1), the present invention is not limited thereto. For example, the mobile communication information may be acquired from data stored in the master terminal 200.

The communication unit 220 may include at least one component that allows communication between the master terminal 200 and at least one slave terminal 300 or between the master terminal 200 and the mobile communication network 400. For example, the communication unit 220 may include a mobile communication module, a wireless Internet module, a wired Internet module, and a short-range communication module.

The mobile communication module transmits or receives a wireless signal to or from at least one of a base station, an external device, and a server on the mobile communication network 400. In this case, the wireless signal may include a voice call, a video call, or various types of data associated with transmission and reception of text/multimedia messages.

The wireless Internet module is configured to provide a wireless Internet connection and may be built into or separated from the communication unit 220. The wired Internet module may be a module for establishing a wired Internet connection.

The short-range communication module refers to a module for performing short-range communication. Examples of short-range communication technologies may include Bluetooth, RFID, IrDA, UWB, ZigBee, Wi-Fi Direct (WFD), and Near Field Communication (NFC).

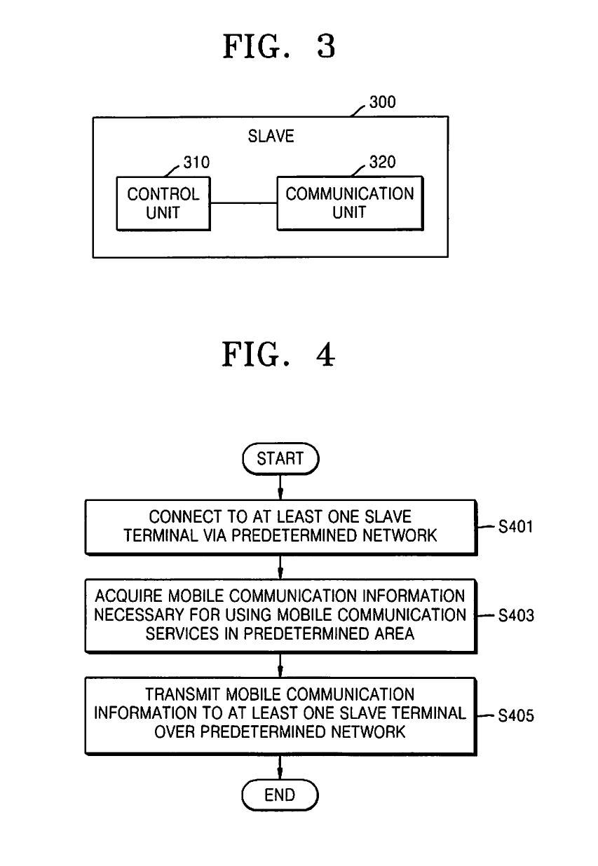

FIG. 3 is a block diagram of an internal configuration of the slave terminal 300.

Referring to FIG. 3, the slave terminal 300 may include a control unit 310 and a communication unit 320. However, both of the components illustrated in FIG. 3 are not essential components. The slave terminal 300 may be realized by fewer or more components than those illustrated in FIG. 3.

The control unit 310 may generally control overall operations of the slave terminal 300. For example, the control unit 310 may control operation of the communication unit 320 so that the communication unit receives mobile communication information necessary for using mobile communication services in a predetermined area from the master terminal (200 in FIG. 1) over a predetermined network. That is, the control unit 310 may control the overall operation of the communication unit 320. The control unit 310 may also control connection to the mobile communication network (400 in FIG. 1) by using the mobile communication information received by the communication unit 320.

In addition, the control unit 310 may determine a base station for exchanging data with the mobile communication network 400, from among base stations to which the slave terminal 300 is able to connect in a predetermined area, based on the mobile communication information. The control unit 310 may also control registration of information about the slave terminal 300 with the mobile communication network 400 through the determined base station.

The communication unit 320 may include at least one component that allows communication between the master terminal 200 and at least one slave terminal 300 or between the master terminal 200 and the mobile communication network 400. For example, the communication unit 320 may include a mobile communication module, a wireless Internet module, a wired Internet module, and a short-range communication module.

The mobile communication module transmits or receives a wireless signal to or from at least one of a base station, an external device, and a server on the mobile communication network 400. In this case, the wireless signal may include a voice call, a video call, or various types of data associated with transmission and reception of text/multimedia messages.

The wireless Internet module is configured to provide wireless Internet connection and may be built into or separated from the communication unit 320. The wired Internet module may be a module for establishing a wired Internet connection.

The short-range communication module refers to a module for performing short-range communication. Examples of short-range communication technologies may include Bluetooth, RFID, IrDA, UWB, ZigBee, WFD, and NFC.

FIG. 4 is a flowchart of a method in which the master terminal 200 provides mobile communication information according to an exemplary embodiment of the present invention.

Referring to FIGS. 1 and 4, the master terminal 200 may connect to at least one slave terminal 300 via a predetermined network (S401).

For example, the master terminal 200 and the at least one slave terminal 300 may be set to a ‘buddy mode’ through applications installed thereon. At least one terminal set to the buddy mode may create a single group, and the terminals in the group may be set as the master terminal 200 and the slave terminal 300. The terminals in the group may be connected to one another via a wired or wireless network.

In this case, the amount of battery consumed by a mobile terminal per unit time to periodically acquire mobile communication information or register information about a mobile terminal with the mobile communication network 400 may be greater than the amount of battery used per unit time to maintain a connection with the master terminal 200 via a predetermined network. The amount of battery consumed by the mobile terminal for periodic acquisition of mobile communication information or registration with the mobile communication network 400 may be usually greater than the amount of battery used per unit time to maintain a short-range wireless network connection such as a Bluetooth connection or Wi-Fi connection.

Thus, the slave terminal 300 may reduce battery consumption by maintaining a short-range wireless network connection with the master terminal 200 instead of periodically acquiring mobile communication information or registering information about the slave terminal 300 because maintaining the short-range wireless connection consumes less battery than periodic acquisition of the mobile communication information or registration of the information about the slave terminal 300. The predetermined network is not limited to the short-range wireless network, and may be constructed using various network technologies.

The master terminal 200 acquires mobile communication information necessary for using mobile communication services in a predetermined area (S403). The master terminal 200 may acquire mobile communication information by obtaining information about a base station to which the master terminal 200 is able to connect at its current location.

The information about the base station may include at least one of information about a cell to which the master terminal 200 belongs, information about a cell adjacent to the cell where the master terminal 200 belongs and information about a new cell into which the master terminal 200 moves.

For example, the master terminal 200 may acquire a list of base stations to which the master terminal 200 is able to connect at its current location and measure signal strengths of the connectable base stations. Alternatively, the master terminal 200 may acquire information about the base station including at least one of the number of mobile terminals currently being connected to each of the base stations, a location of the base station, and ID information of the base station. The information about the base station may be acquired from each base station. The master terminal 200 may also transmit the mobile communication information including information about the base station to which it is able to connect at its current location to the slave terminal 300.

Furthermore, if the master terminal 200 acquires mobile communication information based on a location of the slave terminal 300, the mobile communication information may include information about the base station to be connected to at the location of the slave terminal 300. For example, the master terminal 200 may estimate strength of a signal of the base station, which can be received by the slave terminal 300, based on the location of the slave terminal 300 or the base station. The master terminal 200 may then acquire information about the base station to which the slave terminal 300 is able to connect according to the estimated signal strength of the base station.

The mobile communication information acquired by the master terminal 200 may further include a list of mobile communication service providers providing mobile communication services in a predetermined area. The list of mobile communication service provides may be acquired by performing a manual and home search. The slave terminal 300 may select a mobile communication service provider from the list of mobile communication service providers received from the master terminal 200.

The list of mobile communication service providers may further include information about frequencies and base stations that are used by each of the mobile communication service providers. The slave terminal 300 may determine a base station to be connected thereto by using the information about frequencies and base stations that are used by the selected mobile communication service provider and connect with the mobile communication network 400 through the determined base station.

The master terminal 200 transmits the mobile communication information acquired in the operation S403 to the at least one slave terminal 300 over the short-range network or wired communication network (S405). That is, the master terminal 200 may periodically acquire mobile communication information and transmit the mobile communication information to the at least one slave terminal 300.

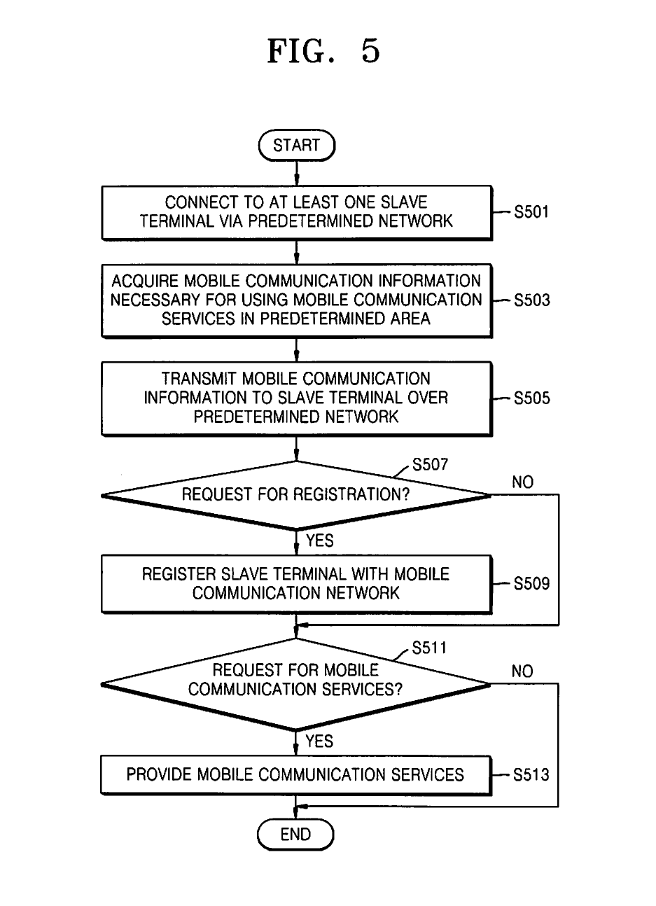

FIG. 5 is a flowchart of a method in which the master terminal 200 provides mobile communication information and mobile communication services according to an exemplary embodiment of the present invention. Since operations S501, S503, and S504 in FIG. 5 correspond to operations S401, S403, and S405 in FIG. 4, respectively, repeated descriptions with respect to FIG. 4 are omitted to avoid redundancy.

Referring to FIGS. 1 and 5, the master terminal 200 connects to at least one slave terminal 300 via a predetermined network (S501)

Thus, the slave terminal 300 may reduce battery consumption by maintaining a short-range wireless network connection or wired network connection instead of periodically acquiring mobile communication information or registering information with the mobile communication network 400 because maintaining the short-range wireless connection or wired network connection consumes less battery than periodic acquisition of the mobile communication information or registration with the mobile communication network 400.

The master terminal 200 acquires mobile communication information necessary for using mobile communication services in a predetermined area (S503). The master terminal 200 may acquire mobile communication information by obtaining information about a base station to which the master terminal 200 or the slave terminal 300 is able to connect at its current location.

The master terminal 200 transmits the mobile communication information acquired in the operation S503 to the at least one slave terminal 300 over the network connected with the at least one slave terminal 300 (S505). That is, the master terminal 200 may periodically acquire mobile communication information and transmit the mobile communication information to the at least one slave terminal 300.

The master terminal 200 determines whether a request for registration with the mobile communication network 400 is received from the slave terminal 300 (S507). For example, the slave terminal 300 requests the master terminal 200 to register information about the slave terminal 300 with the mobile communication network 400. The information about the slave terminal 300 may include information about a base station with which the slave terminal 300 desires a connection at the present point in time.

Upon receipt of the request for registration, the master terminal 200 registers information about the slave terminal 300 with the mobile communication network 400 (S509). In this case, the master terminal 200 may encrypt the information about the slave terminal 300 for transmission to the mobile communication network 400.

After registering the information in step S509, or if it was determined in step S507 that there was no request for registration, the master terminal 200 determines whether a request to provide mobile communication services is received from the slave terminal 300 (S511). The slave terminal 300 may request the master terminal 200 to provide mobile communication services including at least one of voice calling, text messaging, and data services.

The master terminal 200 provides the slave terminal 300 with the mobile communication services according to the request received in operation S511 (S513). In detail, the master terminal 200 may receive data from the slave terminal 300 over the short-range wireless or wired network and transmit the received data to the mobile communication network 400 through a base station connected to the master terminal 200 or the slave terminal 300. The master terminal may also receive data from the mobile communication network 400 via a base station connected to the master terminal 200 or the slave terminal 300 and transmit the received data to the slave terminal 300 over the short-range wireless or wired network.

In this case, the master terminal 200 may transmit or receive data to or from the mobile communication network 400 by using subscriber information related to the master terminal 200 or slave terminal 300. The subscriber information may be identification information about a mobile terminal, which is necessary for using mobile communication services. A mobile terminal may be billed for using mobile communication services based on subscriber information. Thus, the master terminal 200 may use subscriber information related to the master terminal 200 or slave terminal 300 to provide the slave terminal 300 with mobile communication services.

When the master terminal 200 provides mobile communication services to the slave terminal 300 by using subscriber information of the master terminal 200, a service charge may be billed to the master terminal 200 even though the mobile terminal services are actually provided to the slave terminal 300. Thus, if the mobile communication services are provided to the slave terminal 300 through the master terminal 200, it may be determined that only free mobile services are provided to the slave terminal 300. Alternatively, according to settings, it may be determined that both billable and free mobile communication services are provided to the slave terminal 300 through the master terminal 200.

Since frequencies that each mobile terminal uses to connect to the mobile communication network 400 may vary depending on a mobile communication service provider to which the mobile terminal subscribes, each mobile terminal may use a different frequency when connecting to a base station according to a mobile communication service provider. In other words, frequencies that each mobile terminal uses to connect to the base station for connection to the mobile communication network 400 or to search for an available base station may vary depending on the mobile communication service provider to which the mobile terminal subscribes.

For example, if mobile communication service providers to which the master terminal 200 and the slave terminal 300 subscribe are different from each other, the master terminal 200 may search for or connect to a base station by using a different frequency than that used by the slave terminal 300. Thus, information about a base station found by the master terminal 200 during the search may be information about a base station that cannot be used by the slave terminal 300.

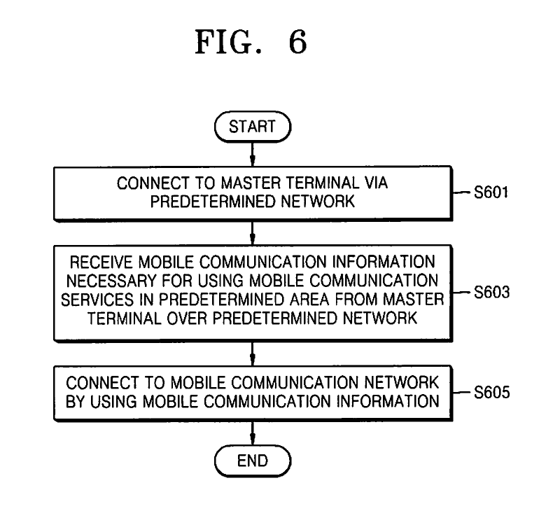

Thus, in one embodiment, if the master terminal 200 and the slave terminal 300 subscribe to different mobile communication service providers, the mobile communication information acquired in the operation S503 may not contain information about a base station to which the master terminal 200 or the slave terminal 300 may be connected. The master terminal 200 may acquire mobile communication information containing a list of mobile communication service providers that provide mobile communication services in the predetermined area instead of the information about a base station to which the master terminal 200 may be connected and transmit the mobile communication information to the slave terminal 300 (S505). On the other hand, if the master terminal 200 and the slave terminal 300 subscribe to the same mobile communication service provider, the master terminal 200 may still transmit to the slave terminal 300 mobile communication information containing a list of mobile communication service providers that provide mobile communication services in the predetermined area. Thus, the slave terminal 300 may use the list of mobile communication service providers contained in the mobile communication information to receive mobile communication services, as described in more detail below with reference to FIG. 6.

In operations S511 and S513, the master terminal 200 may provide mobile communication services to the slave terminal 300 by using subscriber information related to the master terminal 200 or the slave terminal 300. In detail, if the master terminal 200 and the slave terminal 300 subscribe to the same mobile communication service provider, the master terminal 200 may use subscriber information about the slave terminal 300 in order to provide mobile communication services to the slave terminal 300. That is, the mobile communication services may be provided in the same way as the slave terminal 300 uses the mobile communication services.

On the other hand, if the master terminal 200 and the slave terminal 300 subscribe to different mobile communication service providers, the master terminal 200 may use subscriber information about the master terminal 200 in order to provide mobile communication services to the slave terminal 300. That is, the mobile communication services may be provided In the same way as the master terminal 300 uses the mobile communication services.

FIG. 6 is a flowchart of a method of receiving mobile communication information in the slave terminal 300 according to an exemplary embodiment of the present invention.

Referring to FIGS. 1 and 6, the slave terminal 300 may connect to the master terminal 200 via a predetermined network (S601). As the slave terminal 300 and the master terminal 200 are set to a ‘buddy’ mode, they may be connected to each other via the predetermined network.

The slave terminal 300 may receive mobile communication information necessary for using mobile communication services in a predetermined area from the master terminal 200 over the predetermined network (S603). The slave terminal 300 may periodically receive periodically acquired mobile communication information from the master terminal 200.

The mobile communication information that can be received by the slave terminal 300 may include at least one of information about a base station to which a mobile terminal is able to connect, a list of mobile communication service providers available when the mobile terminal is at its current location, information about a cell to which the mobile terminal belongs and cells adjacent to the cell to which the mobile terminal belongs. In this case, the mobile terminal may be the master terminal 200 or slave terminal 300.

The slave terminal 300 may connect to a mobile communication network by using the mobile communication information (S605).

The slave terminal 300 may connect to the mobile communication network by using at least one of information about a cell to which the mobile terminal belongs and a cell adjacent to the cell where the mobile terminal belongs and information about a base station to which the mobile terminal is able to connect, wherein all the information is contained in the mobile communication information.

For example, the slave terminal 300 may determine a base station to be connected to by using at least one of information about a cell to which the mobile terminal belongs, information about a cell adjacent to the cell to which the mobile terminal belongs, and information about a base station to which the mobile terminal is able to connect. The slave terminal 300 may determine a base station to be connected to in consideration of movement speed of the slave terminal 300. If the slave terminal 300 fails to connect to the determined base station, the slave terminal 300 may determine a base station to be connected to among base stations covering cells adjacent to the cell to which the mobile terminal belongs. In this case, the mobile terminal may be the master terminal 200 or the slave terminal 300.

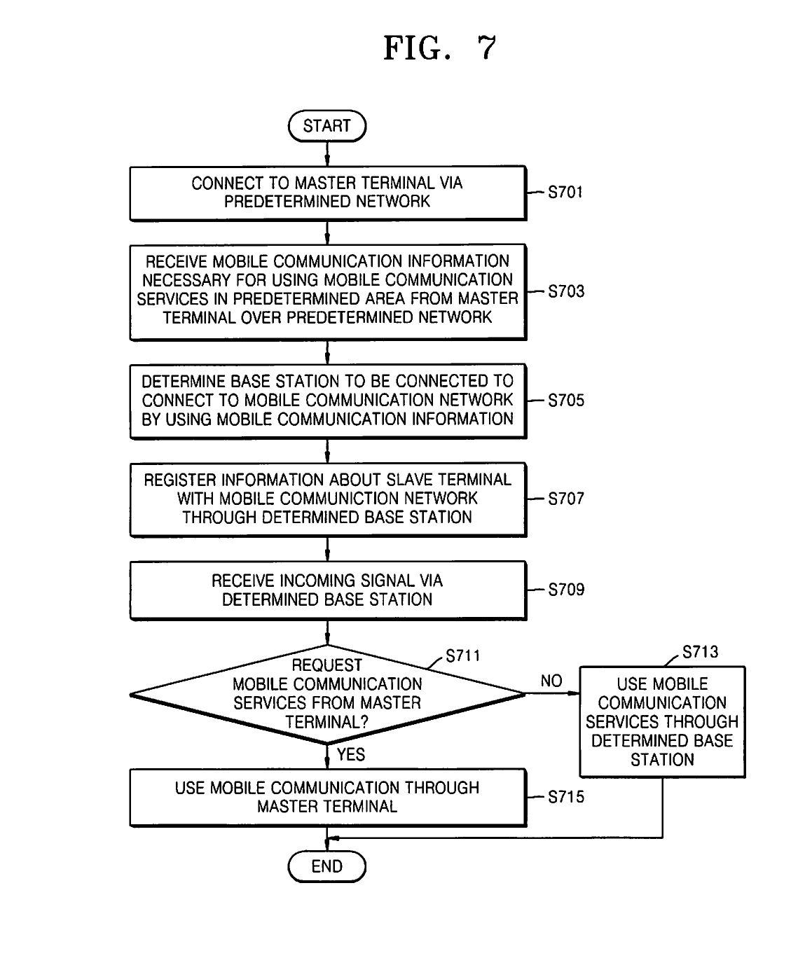

The slave terminal 300 may connect to the mobile communication network 400 through the determined base station. In detail, after registering information about the slave terminal 300 with the mobile communication network 400 through the determined base station, the slave terminal 300 may transmit or receive data needed to use mobile communication services to or from the mobile communication network 400 through the base station. A method of registering information about the slave terminal 300 with the mobile communication network 400 will be described in more detail below with reference to FIG. 7.

Furthermore, the slave terminal 300 may connect to the mobile communication network 400 by using a list of mobile communication service providers providing mobile communication services in a predetermined area, wherein the list is contained in the mobile communication information. In detail, the slave terminal 300 may select a mobile communication service provider that will deliver the mobile communication services, from among the list of mobile communication service providers acquired from the master terminal 200, and connect to a base station that is able to connect to the mobile communication network 400. That is, the slave terminal 300 may connect to the mobile communication network 400 by connecting with the base station via frequencies used by the selected mobile communication service provider. The slave terminal 300 may use mobile communication services after registering information about the slave terminal 300 with the mobile communication network 400 through the base station.

FIG. 7 is a flowchart of a method of receiving mobile communication information and mobile communication services in the slave terminal 300 according to an exemplary embodiment of the present invention. Since operations S701 and S703 illustrated in FIG. 7 correspond to operations S601 and S603 illustrated in FIG. 6, repeated descriptions with respect to FIG. 6 are omitted to avoid redundancy.

Referring to FIGS. 1 and 7, the slave terminal 300 may connect with the master terminal 200 via a short-range wireless or wired network (S701).

The slave terminal 300 may receive mobile communication information necessary for using mobile communication services in a predetermined area from the master terminal 200 over the short-range wireless or wired network (S703). The slave terminal 300 may periodically receive periodically acquired mobile communication information from the master terminal 200.

The slave terminal 300 may determine a base station to be connected to the slave terminal 300 based on the mobile communication information received in operation S703 so as to connect with the mobile communication network 400 (S705).

The slave terminal 300 may register information about the slave terminal 300 with the mobile communication network 400 through the base station determined in the operation S705 (S707).

The information about the slave terminal 300 may include at least one of ID information and location information about the slave terminal 300. The location information about the slave terminal 300 may include information about a cell to which the slave terminal 300 belongs or a base station to which the slave terminal 300 desires to connect. Thus, the mobile communication network 400 may transmit an incoming call received from another device to the slave terminal 300 through the base station connected to the slave terminal 300, based on the information registered with the mobile communication network 400. Alternatively, the mobile communication network 400 may transmit an incoming call to the slave terminal 300 through a base station present in a cell to which the slave terminal 300 belongs.

The slave terminal 300 may receive an incoming call from the mobile communication network 400 via the base station determined in the operation S705 (S709). The incoming call may include a signal requesting the slave terminal 300 to call another device or text messages or data received from another device.

The slave terminal 300 may determine whether to request the master terminal 200 to provide mobile communication services (S711). When the slave terminal 300 initiates and performs a call in response to the incoming call received in operation S709, or transmit an incoming call requesting a call, text messages, or data to another device, the slave terminal 300 may request the master terminal 200 to provide mobile communication services.

For example, the slave terminal 300 may determine whether to request the master terminal 200 for mobile communication services depending on whether the slave terminal 300 and the master terminal 200 subscribe to the same mobile communication service provider, or whether the master terminal 200 is providing mobile communication services to another device. If the slave terminal 300 and the master terminal 200 subscribe to the same mobile communication service provider, the slave terminal 300 may register information about the slave terminal 300 with the mobile communication network 400 to use mobile communication services. Thus, in this case, the slave terminal 300 may not request the master terminal 200 for the mobile communication services.

Furthermore, if the master terminal 200 is providing mobile communication services to another device, the slave terminal 300 may not request the master terminal 200 for mobile communication services because the slave terminal 300 may need to wait more than a predetermined period of time to receive the mobile communication services.

If the slave terminal 300 requests the master terminal 200 to provide the mobile communication services, the slave terminal 300 may use the mobile communication services through the master terminal 200 (S715).

On the other hand, if the slave terminal 300 connects to the mobile communication network 400 to use the mobile communication services instead of requesting the master terminal 200 for the mobile communication services, the slave terminal 300 may use the mobile communication services through the base station determined in operation S705 (S713). That is, the slave terminal 300 may make a call or transmit text messages or data to another device according to the incoming call received in operation S709 through the base station determined in operation S705.

Although the slave terminal 300 performs operations S711, S713, and S715 after receiving the incoming call in operation S709, it may perform the operations S711, S713, and S715 without having received the incoming call. In detail, if the slave terminal 300 desires to transmit a text message, data, or an incoming call requesting a call to another device, the slave terminal 300 may also perform the operations S711 S713, and S715.

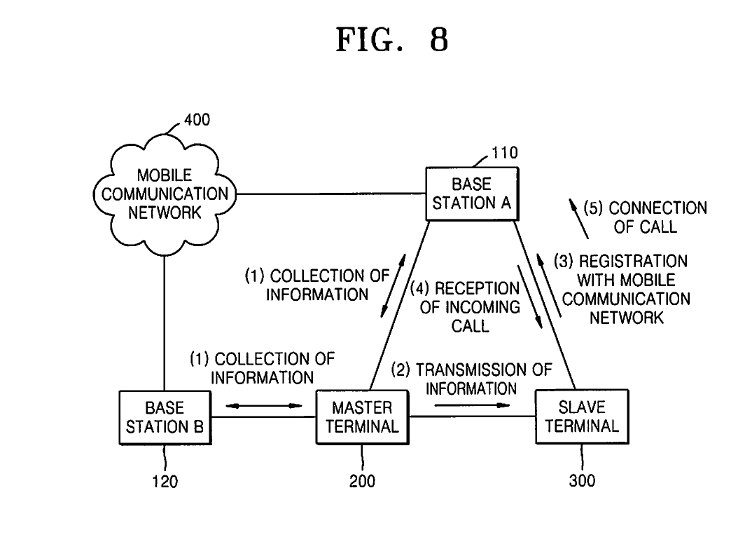

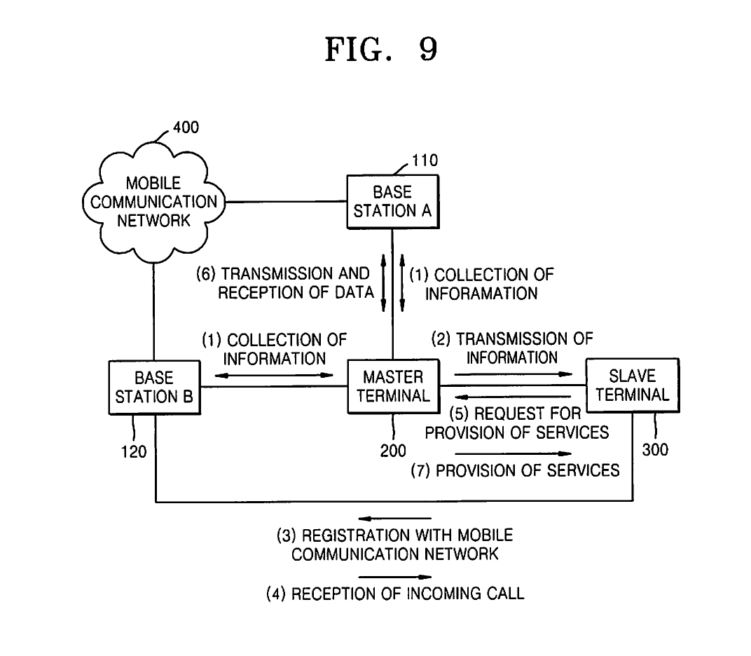

FIGS. 8 and 9 are exemplary diagrams of a method of providing mobile communication information and mobile communication services according to exemplary embodiments of the present invention.

FIG. 8 is an exemplary diagram illustrating a method whereby a slave terminal 300 uses mobile communication services directly through a base station, and FIG. 9 is an exemplary diagram illustrating a method whereby a slave terminal 300 uses mobile communication services through a master terminal 200.

A method of using mobile communication services directly through a base station will now be described in detail with reference to FIG. 8.

Referring to FIG. 8, the master terminal 200 may acquire mobile communication information including information about a base station to which the master terminal 200 or the slave terminal 300 is able to connect, e.g., base station A 110 or base station B 120 (operation (1): collection of information). The master terminal 200 may acquire information about a cell to which the master terminal 200 or the slave terminal 300 belongs or cells adjacent to the cell. In addition, the master terminal 200 may acquire a list of mobile communication service providers that can be used by the master terminal 200 or the slave terminal 300.

The master terminal 200 may transmit the mobile communication information to the slave terminal 300 (operation (2): transmission of information). The master terminal 200 may transmit the mobile communication information either periodically or upon request from the slave terminal 300.

The slave terminal 300 may register information about the slave terminal 300 with a mobile communication network 100 by using the mobile communication information received in operation (2) (operation (3): registration with mobile communication network). The slave terminal 300 may determine a base station to be connected to use the mobile communication services and register information about the slave terminal 300 with the mobile communication network 100 via the base station A 110. By doing so, the slave terminal 300 may receive an incoming call from the mobile communication network 400 via the base station A 110.

The slave terminal 300 may receive an incoming call from another device via the base station A 110 (operation (4): reception of incoming call).

In response to the received incoming call, the slave terminal 300 may make a call with the device that has forwarded the incoming call through the base station A 110 (operation (5) connection of a call).

A method of using mobile communication services through the master terminal 200 will now be described in more detail with reference to FIG. 9. Since operations (1) through (4) (collection of information through reception of an incoming call) correspond to operations (1) through (4) illustrated in FIG. 8, repeated descriptions with respect to FIG. 8 are omitted to avoid redundancy.

Referring to FIG. 9, the master terminal 200 may acquire mobile communication information including information about a base station to which the master terminal 200 or the slave terminal 300 is able to connect, e.g., base station A110 or base station B 120 (operation (1): collection of information).

The master terminal 200 may transmit mobile communication information acquired in operation (1) to the slave terminal 300 (operation (2): transmission of information).

The slave terminal 300 may register information about the slave terminal 300 with the mobile communication network 100 by using mobile communication information received in operation (2) (operation (3): registration with mobile communication network). The slave terminal 300 may determine a base station to be connected to use mobile communication services and register information about the slave terminal 300 with the mobile communication network 100 via the base station B 120. By doing so, the slave terminal 300 may receive an incoming call from the mobile communication network 100 via the base station B 120.

The slave terminal 300 may receive an incoming call forwarded from another device via the base station B 120 (operation (4): reception of incoming call).

The slave terminal 300 may request the master terminal 200 to provide mobile communication services in order to make a call in response to the incoming call (operation (5): request for provision of services). Furthermore, when the slave terminal 300 desires to transmit an incoming call, a text message, or data to another device without receiving the incoming call, the slave terminal 300 may request the master terminal 200 to provide mobile communication services.

Upon receipt of the request from the slave terminal 300, the master terminal 200 may transmit or receive data to be transmitted to the slave terminal 300_to or from the base station A 110 connected to the master terminal 200 (operation (6): transmission and reception of data).

The master terminal 200 may transmit data received from the base station A 110 to the slave terminal 300 (operation (7): provision of services). The master terminal 200 may transmit data received from the slave terminal 300 through the base station A 110.

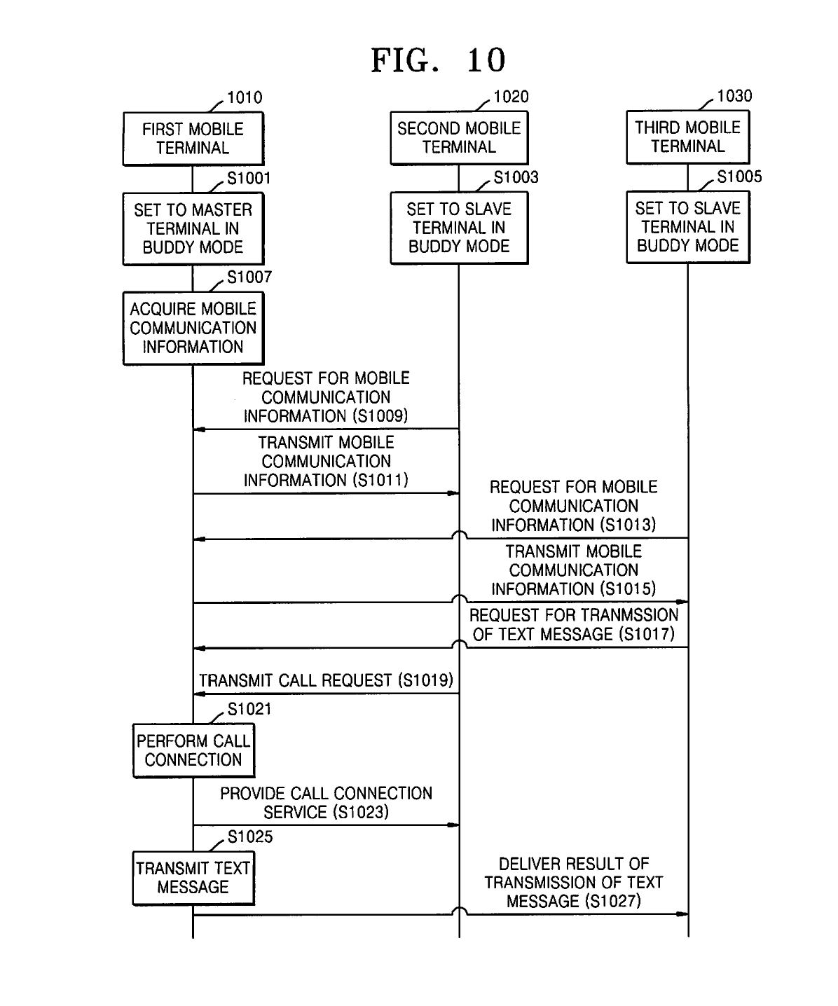

FIG. 10 is a flowchart of a method of providing mobile communication information and mobile communication services according to another exemplary embodiment of the present invention.

Referring to FIG. 10, the first through third mobile terminals 1010 through 1030 form a single group. The first mobile terminal 1010 may be set as a master terminal (S1001), and the second and third mobile terminals 1020 and 1030 may be set as slave terminals, respectively (S1003 and S1005).

The first mobile terminal 1010 may connect to at least one base station via frequencies that are used by the first mobile terminal 1010 and acquire mobile communication information necessary for using mobile communication services (S1007). The first mobile terminal 1010 may periodically acquire mobile communication information because a base station that it may connect to may vary as the first mobile terminal 100 moves.

The second mobile terminal 1020 may request transmission of mobile communication information from the first mobile terminal 1010 set as the master terminal (S1009).

The first mobile terminal 1010 may transmit the mobile communication information acquired in operation S1007 to the second mobile terminal 1020 (S1011).

The third mobile terminal 1030 may request transmission of mobile communication information from the first mobile terminal 1010 set as the master terminal (S1013).

The first mobile terminal 1010 may transmit the mobile communication information acquired in operation S1007 to the third mobile terminal 1030 (S1015).

The third and second mobile terminals 1030 and 1020 may request the first mobile terminal 1010 for provision of mobile communication services, i.e., transmission of a text message (S1017) and transmission of a call request (S1019), respectively.

When the first mobile terminal 1010 receives a request for mobile communication services simultaneously from at least one slave terminal, the first mobile terminal 1010 may sequentially provide mobile communication services in order of highest priority to the lowest. For example, when a calling service has higher priority than a text messaging service, the first mobile terminal 1010 first provides the calling service to transmit and receive data associated therewith and thereafter transmits a text message.

Thus, the first mobile terminal 1010 may perform a call connection to first provide a call service having a high priority (S1021), and provide a call connection service to the second mobile terminal 1020 (S1023).

When the first mobile terminal 1010 terminates the call connection service, or when the call connection service ceases to be provided or the second mobile terminal 1010 is ready to transmit a text message to the mobile communication network, the first mobile terminal 1010 may transmit the text message received in operation S1017 to the mobile communication network 100 (S1025). The first mobile terminal 1010 may deliver the result of transmission of the text message to the third mobile terminal 1030 (S1027).

As described above, according to the one or more of the above embodiments of the present invention, a mobile terminal may maintain a connection to a mobile communication network through a master terminal, thereby reducing battery consumption therein.

The mobile terminal may also acquire mobile communication information necessary for using mobile communication services, thereby reducing battery consumption therein.

Furthermore, the mobile terminal may use mobile communication services through a master terminal in the absence of a base station connectable thereto.

In addition, the mobile terminal may access mobile communication services through a master terminal capable of using the mobile communication services.

The methods according to the above embodiments of the present invention can be implemented on a computer-readable medium as codes that can be read by a computer (including all devices having information processing capabilities). The computer-readable recording medium is any recording media having stored thereon data that can be read by a computer system. Examples of the computer-readable recording medium include ROM, RAM, CD-ROM, magnetic tapes, floppy disks, and optical data storage devices.

While the above descriptions that apply to various embodiments of the present invention are focused on new features of the present invention, it will be understood by those of ordinary skill in the art that various deletions, substitutions, and changes in form and details of the systems and methods described above may be made therein without departing from the spirit and scope of the present invention as defined by the following claims. The scope of the invention is defined not by the detailed description of the invention but by the appended claims, and all differences within the scope of the appended claims and their equivalents will be construed as being included in the present invention.

What is claimed is:

1. A method of providing mobile communication information, the method comprising:
acquiring, by a master terminal, mobile communication information necessary for using mobile communication services in a predetermined area, wherein the master terminal is connected to at least one slave terminal via a predetermined network; and
transmitting the mobile communication information to the at least one slave terminal via the predetermined network.

2. The method of claim 1, wherein the predetermined network is a short-range communication network.

3. The method of claim 1, further comprising registering information about the at least one slave terminal with a mobile communication network by using the mobile communication information, upon request of the at least one slave terminal, so that the at least one slave terminal is connected to the mobile communication network.

4. The method of claim 1, further comprising providing, upon request of the at least one slave terminal, the mobile communication services to the at least one slave terminal by using the mobile communication information, wherein the mobile communication services include at least one of text messaging, calling, and data provision services.

5. The method of claim 1, wherein acquiring the mobile communication information comprises acquiring the mobile communication information at predetermined time intervals.

6. The method of claim 1, wherein the mobile communication information comprises a list of mobile communication service providers of each mobile communication network that is connectable with a mobile terminal in the predetermined area.

7. A method of connecting to a mobile communication network, the method comprising:
connecting to a master terminal via a predetermined network;
receiving mobile communication information including information necessary for using mobile communication services in a predetermined area from the master terminal via the predetermined network; and
connecting to a mobile communication network by using the received mobile communication information.

8. The method of claim 7, wherein the predetermined network is a short-range communication network.

9. The method of claim 7, wherein connecting the mobile communication network comprises registering information about at least one slave terminal with the mobile communication network by using the mobile communication information so that the at least one slave terminal is connected to the mobile communication network.

10. The method of claim 9, wherein registering information about the at least one slave terminal comprises:
determining a base station that will receive an incoming call, from among base stations that are connectable in the predetermined area; and
registering information about the at least one slave terminal with the mobile communication network based on a result of determination.

11. The method of claim 10, wherein connecting the mobile communication network further comprises receiving the incoming call through the determined base station.

12. The method of claim 7, wherein the mobile communication information comprises a list of mobile communication service providers of each mobile communication network that is connectable with a mobile terminal in the predetermined area, and
wherein the connecting to the mobile communication network comprises selecting at least one mobile communication service provider from the list of mobile communication service providers and connecting to a mobile communication network used by the selected mobile communication service provider.

13. The method of claim 7, wherein
receiving the mobile communication information comprises receiving the mobile communication information at predetermined time intervals and updating the mobile communication information with the received mobile communication information, and
wherein connecting the mobile communication network comprises connecting to the mobile communication network by using the updated mobile communication information.

14. A slave terminal comprising:
a communication unit that configured to connect to a master terminal via a predetermined network and receives mobile communication information including information necessary for using mobile communication services in a predetermined area from the master terminal via the predetermined network; and
a control unit configured to control connection to a mobile communication network by using the received mobile communication information.

15. The slave terminal of claim 14, wherein the control unit is configured to control registration of information about the slave terminal with the mobile communication network by using the mobile communication information so that the slave terminal is connected to the mobile communication network.

16. The slave terminal of claim 15, wherein the control unit is configured to determine a base station that will receive an incoming call, from among base stations that are connectable in the predetermined area, based on the mobile communication information, and to register information about the slave terminal with the mobile communication network based on a result of determination.

17. The slave terminal of claim 14, wherein the mobile communication information comprises a list of mobile communication service providers of each mobile communication network that is connectable with a mobile terminal in the predetermined area, and
wherein the control unit is configured to select at least one mobile communication service provider from the list of mobile communication service providers, and to control connection to a mobile communication network used by the selected mobile communication service provider.

18. The slave terminal of claim 14, wherein the communication unit is configured to receive the mobile communication information at predetermined time intervals, and
wherein the control unit is configured to update the mobile communication information with the received mobile communication information, and to control connection to the mobile communication network by using the updated mobile communication information.

19. A non-transitory computer-readable recording medium having recorded thereon a program, which when executed performs a method of providing mobile connection information, the method comprising:
acquiring, by a master terminal mobile communication information necessary for using mobile communication services in a predetermined area, wherein the master terminal is connected to at least one slave terminal via a predetermined network; and
transmitting the mobile communication information to the at least one slave terminal via the predetermined network.

20. A non-transitory computer-readable recording medium having recorded thereon a program, which when executed performs a method connecting to a mobile communication network, the method comprising:
connecting to a master terminal via a predetermined network;
receiving mobile communication information including information necessary for using mobile communication services in a predetermined area from the master terminal via the predetermined network; and
connecting to a mobile communication network by using the received mobile communication information.
